(19) United States
(12) Patent Application Publication
(10) Pub. No.: US 2022/0044513 A1
(43) Pub. Date: Feb. 10, 2022

(54) System, Method, and Non-Transitory Computer-Readable Storage Media for Facilitation of Voter Registration

(71) Applicant: McDuffie Group, LLC, Peoria, IL (US)

(72) Inventor: Jonathon R. Braun, Peoria, IL (US)

(73) Assignee: McDuffie Group, LLC, Peoria, IL (US)

(21) Appl. No.: 17/397,821

(22) Filed: Aug. 9, 2021

Related U.S. Application Data
(60) Provisional application No. 63/063,669, filed on Aug. 10, 2020.

(51) Int. Cl. G07C 13/00

(52) U.S. Cl. CPC G07C 13/00

(57) ABSTRACT

A system, method, and computer product to allow users to access voting and ballot information. The system comprises a database stored on a server and an application installed on a user device accessible to a user, wherein the user device includes a user interface. The system further comprises a processing device of the server, wherein the processing device is in communication with the user interface, the processing device including a hosting unit configured to prompt a user to access the application, and display voter information associated with the user. The processing device further comprises a voting management unit configured to maintain voting information, and a communications unit configured to send information about voting to the user.

### CROSS-REFERENCE TO RELATED APPLICATIONS

This application claims priority to and the benefit of U.S. Provisional Patent Application No. 63/063,669, filed on Aug. 10, 2020, the entire contents of which are hereby incorporated by reference.

### FIELD OF THE DISCLOSURE

The present invention relates to systems, methods, and computer-readable storage media that allow users to access current voter and ballot information.

### SUMMARY OF THE INVENTION

In different embodiments of the present invention, systems, methods, and computer-readable storage media to allow users to access current voter and ballot information.

In one aspect of the present invention, a system comprises a database stored on a server and an application installed on a user device accessible to a user, wherein the user device includes a user interface. The system further comprises a processing device of the server, wherein the processing device is in communication with the user interface, the processing device including a hosting unit configured to prompt a user to access the application, and display voter information associated with the user. The processing device further comprises a voting management unit configured to maintain voting information, and a communications unit configured to send information about voting to the user.

In another embodiment of the present invention, a computer-implemented method is provided. The method comprises a first step of prompting a user to access, by a hosting unit and a communications unit, a voter mobile application. The method further comprises a second step of displaying, by the hosting unit, a current ballot associated with the user. The method comprises a third step of prompting the user, by the hosting unit, to select a voting option to indicate a preferred response associated with the user on the ballot. The method comprises a fourth step of storing, in a database, the selected voting option. The method comprises a fifth step of displaying, by the hosting unit, all voting options associated with the current ballot selected by the user.

In still another embodiment of the present invention, one or more non-transitory computer-readable storage media, having computer-executable instructions embodied thereon, wherein when executed by at least one processor, the computer-executable instructions cause the processor to operate as a system including a database stored on a server and an application installed on a user device accessible to a user, wherein the user device includes a user interface. The system further comprises a processing device of the server, wherein the processing device is in communication with the user interface, the processing device including a hosting unit configured to prompt a user to access the application, and display voter information associated with the user. The processing device further comprises a voting management unit configured to maintain voting information, and a communications unit configured to send information about voting to the user.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present disclosure;

FIG. 2 is a schematic illustrating example components of a server, according to a first embodiment of the present invention;

FIG. 3 is a flowchart of a method that may be used with the system shown in FIG. 1, according to a first embodiment of the present invention;

FIG. 4 is an illustrative screenshot of a login screen of an exemplary mobile application utilizing system 10;

FIG. 5 is an illustrative screenshot of an account creation screen of an exemplary mobile application utilizing system 10;

FIG. 6 is an illustrative screenshot of a home screen of an exemplary mobile application utilizing system 10;

FIG. 7 is an illustrative screenshot of a user profile screen of an exemplary mobile application utilizing system 10;

FIG. 8 is an illustrative screenshot of a polling place screen of an exemplary mobile application utilizing system 10;

FIG. 9 is an illustrative screenshot of a voter registration screen of an exemplary mobile application utilizing system 10;

FIG. 10 is an illustrative screenshot of a ballot screen of an exemplary mobile application utilizing system 10;

FIG. 11 is an illustrative screenshot of a candidate's screen of an exemplary mobile application utilizing system 10;

FIG. 12 is an illustrative screenshot of a candidate profile screen of an exemplary mobile application utilizing system 10;

FIG. 13 is an illustrative screenshot of a candidate biography screen of an exemplary mobile application utilizing system 10;

FIG. 14 is an illustrative screenshot of a candidate policies screen of an exemplary mobile application utilizing system 10;

FIG. 15 is an illustrative screenshot of a resolutions screen of an exemplary mobile application utilizing system 10;

FIG. 16 is an illustrative screenshot of an information screen of an exemplary mobile application utilizing system 10; and

FIG. 17 is a flowchart of a voter preference selection and storage method that may be used with the system shown in FIG. 1.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

With reference to the FIGS. and in operation, the present invention provides a voter registration facilitation system 10, methods and computer product media to facilitate voter registration. In general use, the system includes a processing device of a service that allows a user (e.g., a voter or potential voter) to register to vote, view polling place information, view candidate information, and view or locate other voting-related information via a website or an application, i.e., “app”, running on a user device.

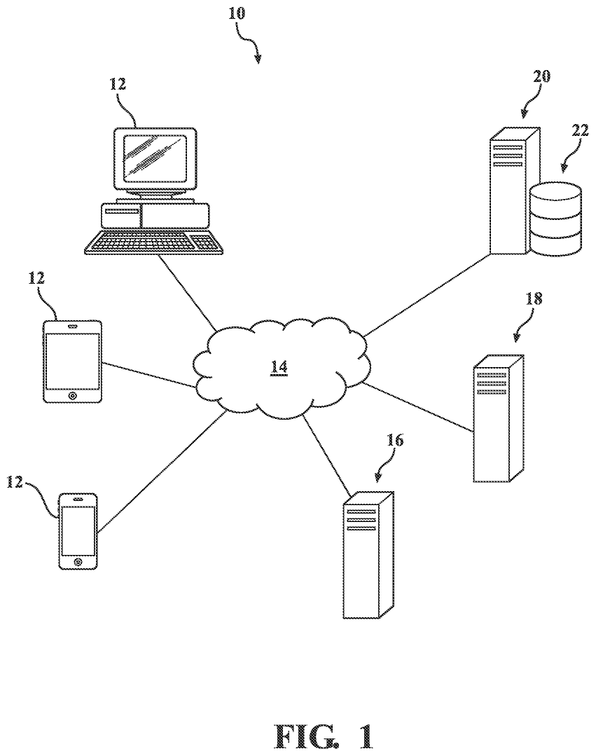

Referring to FIG. 1, an exemplary environment in which the system 10 operates is illustrated. In the illustrated embodiment, the system 10 is configured to enable a user to access a website with one or more user computing devices 12.

For clarity in discussing the various functions of the system 10, multiple computers and/or servers are discussed as performing different functions. These different computers (or servers) may, however, be implemented in multiple different ways such as modules within a single computer, as nodes of a computer system, etc. The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

In the illustrated embodiment, the system 10 includes a hosting server 16, a server 18, a database server 20, a database 22, and one or more user computing (or customer) devices 12 that are each coupled in communication via a communications network 14. The communications network 14 may be any suitable connection, including the Internet, file transfer protocol (FTP), an Intranet, LAN, a virtual private network (VPN), cellular networks, etc., and may utilize any suitable or combination of technologies including, but not limited to wired and wireless connections, always on connections, connections made periodically, and connections made as needed.

The user computing device 12 may include any suitable device that enables a user to access and communicate with the system 10 including sending and/or receiving information to and from the system 10 and displaying information received from the system 10 to a user. For example, in one embodiment, the user computing device 12 may include, but is not limited to, a desktop computer, a laptop or notebook computer, a tablet computer, smartphone/tablet computer hybrid, a personal data assistant, a handheld mobile device including a cellular telephone, and the like.

The hosting server 16 may be configured to host a website or provide data to the app that is accessible by a user via one or more user computing devices 12. For example, the hosting server 16 may retrieve and store a web page associated with one or more websites in response to requests received by the user via the user computing device 12 to allow users to interact with the website. In one embodiment, the hosting server 16 is configured to generate and display a web page associated with the website in response to requests being received from consumers via corresponding web browsers that are displayed on the user computing devices 12.

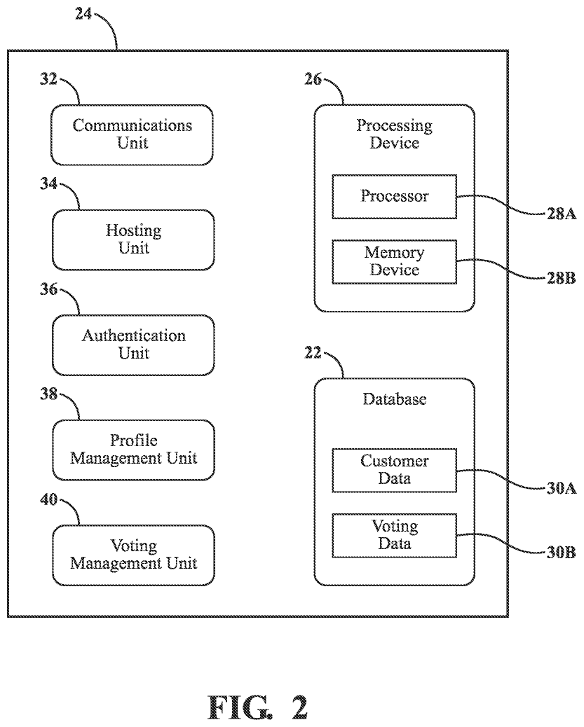

Referring to FIG. 2, in one embodiment, the system 10 may include a system server 24 that is configured to perform the functions of the hosting server 16, the server 18, and/or the database server 20. In the illustrated embodiment, the system server 24 includes a processing device 26 and the database 22.

The processing device 26 executes various programs, and thereby controls components of the system server 24 according to user instructions received from the user computing device 12. The processing device 26 may include a processor or processors 28A and a memory device 28B, e.g., read only memory (ROM) and random access memory (RAM), storing processor-executable instructions and one or more processors that execute the processor-executable instructions. In embodiments where the processing device 26 includes two or more processors 28A, the processors 28A can operate in a parallel or distributed manner. In an example, the processing device 26 may execute and/or implement a communications unit 32, a hosting unit 34, an authentication unit 36, a profile management unit 38, and a voting management unit 40.

The processing device 26 includes a memory device 28A that is connected to the database 22 to retrieve and store information contained in the database 22. The database 22 contains information on a variety of matters, such as, for example, customer account/profile data 30A, voting data 30B (including candidate/resolution information), and/or any suitable information that enables the system 10 to function as described herein.

The memory device 28B may be configured to store programs and information in the database 22 and retrieve information from the database 22 that is used by the processor to perform various functions described herein. The memory device 28B may include, but is not limited to, a hard disc drive, an optical disc drive, and/or a flash memory drive. Further, the memory device may be distributed and located at multiple locations.

In one embodiment of the present invention, the memory device 28B may include one or more of the memory devices and/or mass storage devices of one or more of the computing devices or servers. The modules that comprise the invention are composed of a combination of hardware and software, i.e., the hardware as modified by the applicable software applications. In one embodiment, the units of the present invention are comprised of one of more of the components of one or more of the computing devices or servers, as modified by one or more software applications.

The communications unit 32 retrieves various data and information from the database 22 and sends information to the user computing device 12 via the communications network 14 to enable the user to access and interact with the system 10. In one embodiment, the communications unit 32 displays various images on a graphical interface of the user computing device 12 preferably by using computer graphics and image data stored in the database 22 including, but not limited to, web pages and/or any suitable information and/or images that enable the system 10 to function as described herein.

The hosting unit 34 may be programmed to perform some or all of the functions of the hosting server 16 including hosting various web pages associated with one or more websites that are stored in the database 22 and that are accessible to the user via the user computing device 12. The hosting unit 34 may be programmed to generate and display web pages associated with a website in response to requests being received from users via corresponding web browsers.

In one embodiment of the present invention, the authentication unit 36 may authenticate requests received from users via user computing device 12. The memory device 28B may retrieve information from the database 22 about the user to determine authentication.

The profile management unit 38 may maintain a plurality of profiles associated with users stored in database 22.

The voting management unit 40 may be programmed to maintain voting information, including voter registration information, as well as information about polling places, ballots, candidates, and resolutions.

The communications unit 32 may further send information about voting to the user, such as by e-mail, text message, or push notification.

Although FIG. 2 illustrates a block diagram of system server 24, it will be understood that hosting server 16, database server 20, and/or server 18 may have the same or similar architecture as illustrated with respect to system server 24 in FIG. 2.

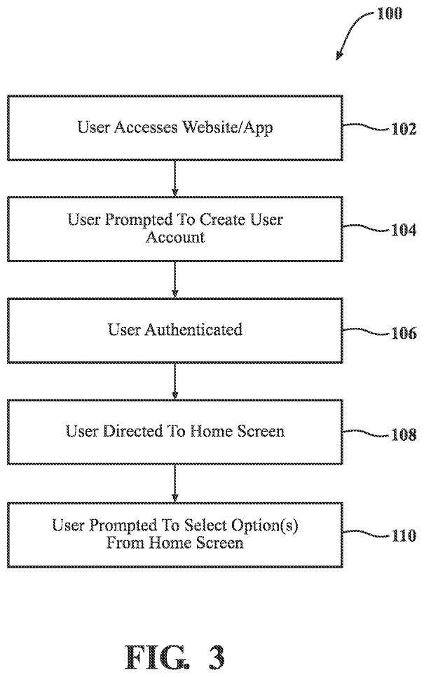

FIG. 3 is a flowchart of method 100 that may be used with the system 10 to allow a processing device to facilitate voter registration. The method includes a plurality of steps. Each method step may be performed independently of, or in combination with, other method steps. Portions of the method may be performed by any one of, or any combination of, the components of the system 10.

In a first step 102, a user accesses, via the communications unit 32 and the hosting unit 34, a website or mobile application. The first time the user accesses the website or mobile application, the user is considered a guest, but may be required to register a user account.

In a second step 104, the user may be prompted, by the profile management unit 38, to create a user account. The user may be required to provide personal information, e.g., name, address, phone number, e-mail address, password, school affiliation, party affiliation, and any other information relevant to voter registration.

In a third step 106, the authentication unit 36 may verify the user's information and authenticate the user as a registered user.

In a fourth step 108, the user may be directed to a home screen, which may include, for example, options to select to view information about upcoming ballot(s) associated with the user, polling place(s) associated with the user, registering to vote, user profile, or other information. The user may be able to select to exit the application from the home screen.

In a fifth step 110, the user may be prompted to select one or more options from the home screen to utilize various functions of the mobile application.

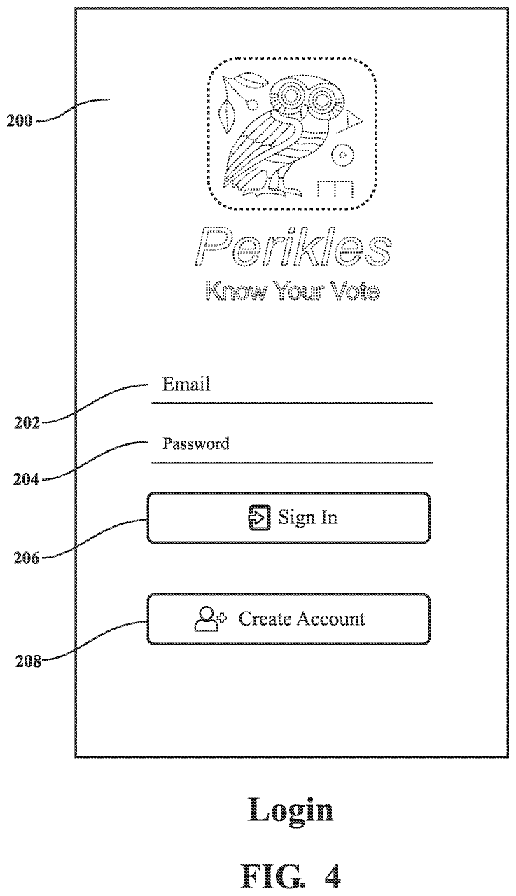

FIGS. 4-16 are illustrative screenshots of an exemplary mobile application utilizing system 10.

FIG. 4 is an illustrative screenshot of a login screen of an exemplary mobile application utilizing system 10. From login screen 200, a registered user may be prompted to enter login credentials, such as, for example, a screen name or email address 202 and a password 204. A user may select a sign-in button 206. The communications unit 32 may send an authentication request to the authentication unit 36 to validate the login credentials. The authentication unit 36 may compare the login credentials against information stored about the user in database 22. In some embodiments, a guest user may access, via the communications unit 32 and the hosting unit 34, a website or mobile application via a guest link available on login screen 200. In some embodiments, an unregistered user may be required to register before accessing various functions of the mobile application. An unregistered user may select an account creation button 208 to begin the account creation process.

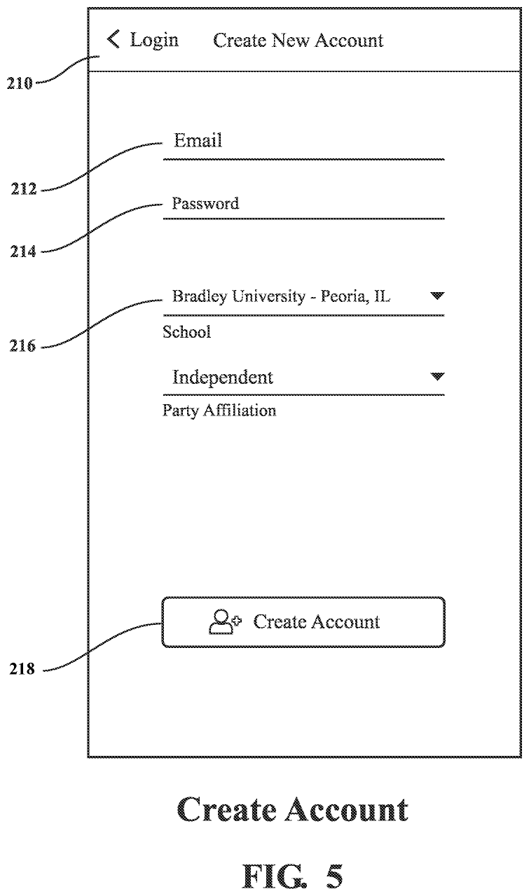

FIG. 5 is an illustrative screenshot of an account creation screen of an exemplary mobile application utilizing system 10. From an account creation screen 210, the user may be prompted, by the profile management unit 38, to enter login credentials, for example, an email address or username 212, and to create a password 214. The user may also be prompted to enter other personal information 216, which may include, for example, name, address, phone number, school affiliation, party affiliation, and any other information relevant to voter registration. The user may then select a “create account” button 218 to complete the account creation process.

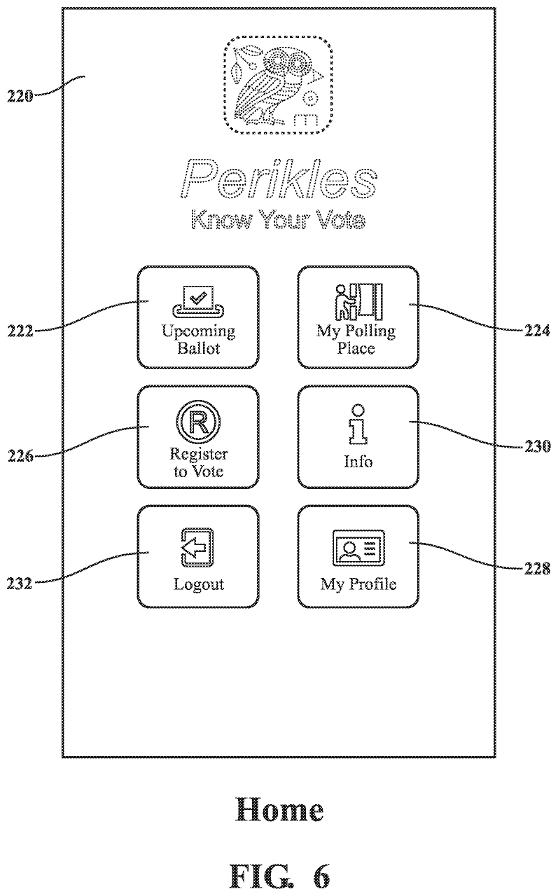

FIG. 6 is an illustrative screenshot of a home screen of an exemplary mobile application utilizing system 10. From a home screen 220, the user may access various information and other functions, including, for example, for example, options to select to view information about upcoming ballot information 222, polling place information 224, registering to vote function/information 226, user profile 228, or other information 230. The user may be able to select to exit the application from the home screen using logout function 232.

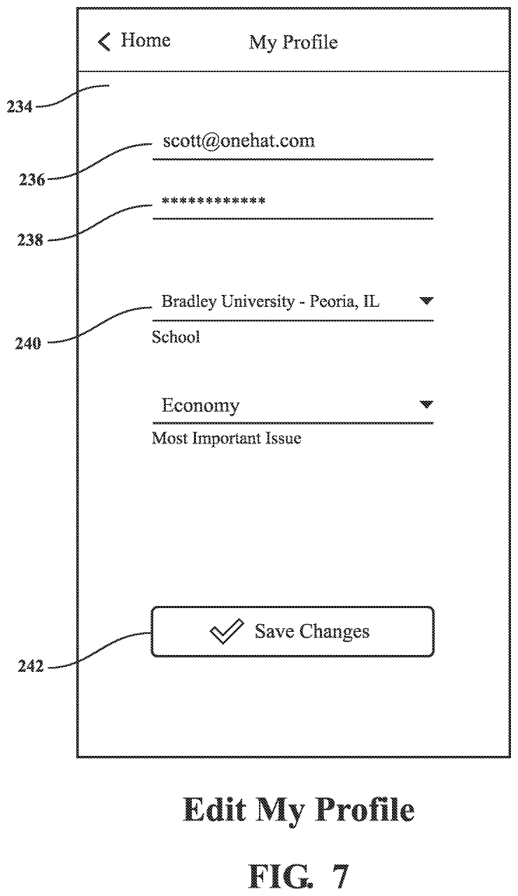

FIG. 7 is an illustrative screenshot of a user profile screen of an exemplary mobile application utilizing system 10. By selecting user profile function 228 from home screen 220, the user may be directed to a user profile screen 234. From user profile screen 234, the user may change login credentials, such as username or email address 236 and password 238. The user may also change other personal information 240, which may include, for example, name, address, phone number, school affiliation, party affiliation, and any other information relevant to voter registration. The user may then select a “save changes” button 242 to save changes to the user's profile.

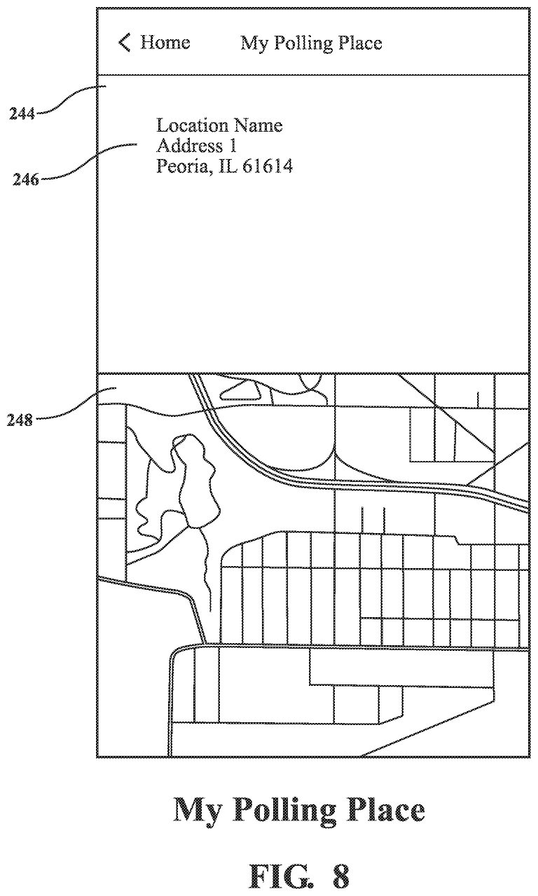

FIG. 8 is an illustrative screenshot of a polling place screen of an exemplary mobile application utilizing system 10. By selecting polling place function 224 from home screen 220, the user may be directed to a polling place screen 244. Information about one or more polling places associated with the user, including, for example an address 246 and/or a map 248, may be displayed on polling place screen 244.

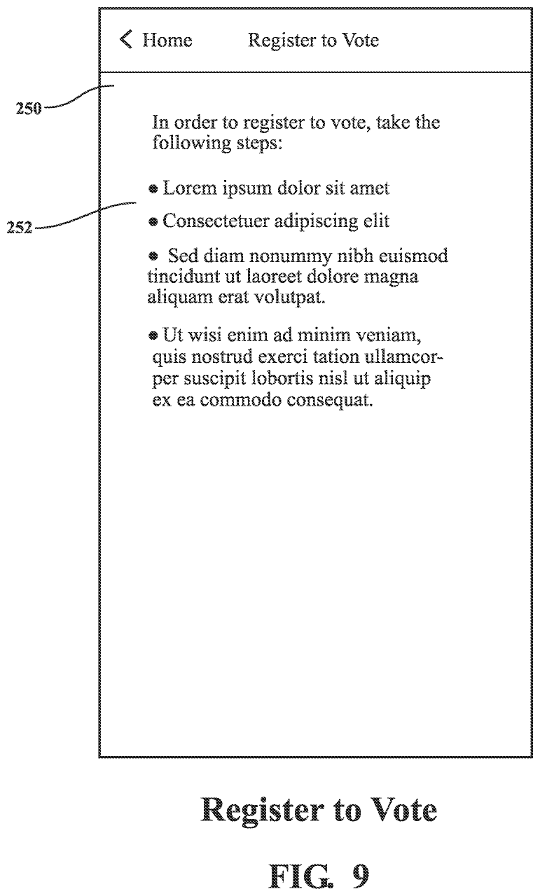

FIG. 9 is an illustrative screenshot of a voter registration screen of an exemplary mobile application utilizing system 10. By selecting registering to vote function/information 226 from home screen 220, the user may be directed to a voter registration screen 250. On voter registration 250, information about the steps required to register to vote, along with any other relevant information 252 relevant to registering to vote, may be displayed. In some embodiments, voter registration screen 252 may allow the user to register to vote directly from system 10, and/or provide links to third party voter registration systems.

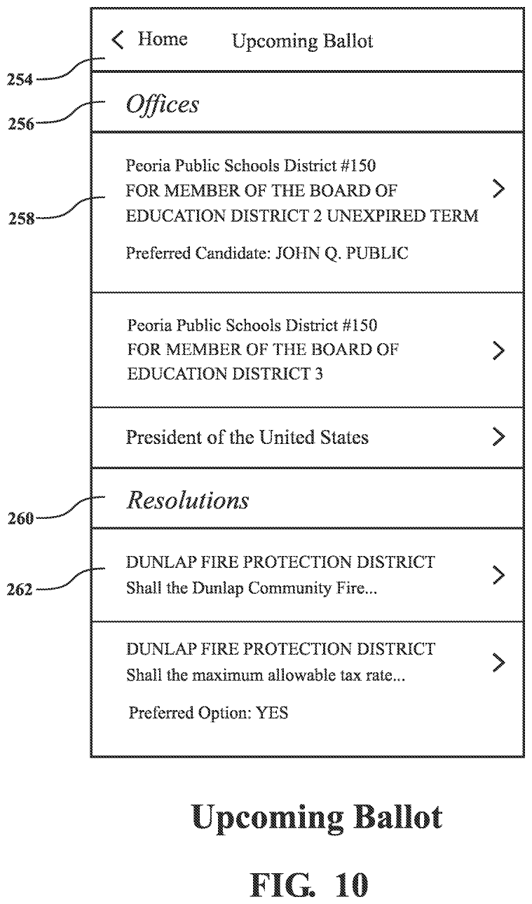

FIG. 10 is an illustrative screenshot of a ballot screen of an exemplary mobile application utilizing system 10. By selecting upcoming ballot information 222 from home screen 220, the user may be directed to a ballot screen 254. On ballot screen 254, information about upcoming ballots associated with the user may be displayed, including, for example, offices 256, under which various open offices 258 may be listed, and resolutions 260, under which various resolutions 262 may be listed. Each office 258 and/or resolution 260 may be selectable such that the user may select one or more of the options to view more information.

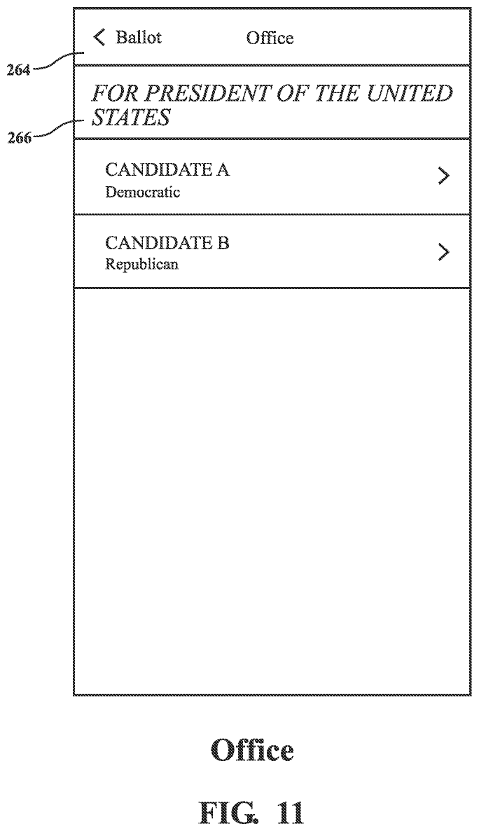

FIG. 11 is an illustrative screenshot of a candidate's screen of an exemplary mobile application utilizing system 10. By selecting an open office 258 from ballot screen 254, the user may be directed to a candidate's screen 264. On candidate screen 264, information about all candidates 266 running for an office may be displayed (e.g., by name or by affiliated party). Each candidate listed under all candidates 266 may be selectable such that the user may select one or more of the options to view more information.

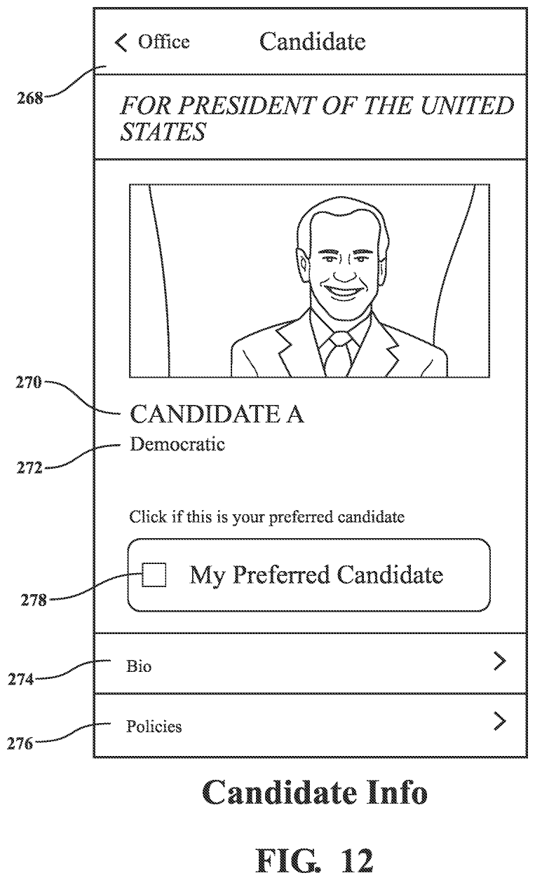

FIG. 12 is an illustrative screenshot of a candidate profile screen of an exemplary mobile application utilizing system 10. By selecting a candidate from all candidates 266 from candidate's screen 264, the user may be directed to a candidate profile screen 268. On candidate profile screen 268, information about a candidate may be displayed, including, for example, name 270, affiliated party 272, biography 274, and policies 276. In some embodiments, there may also be a checkbox 278 that a user may check if the candidate is the user's preferred candidate, to assist a user in keeping track of their voting preferences.

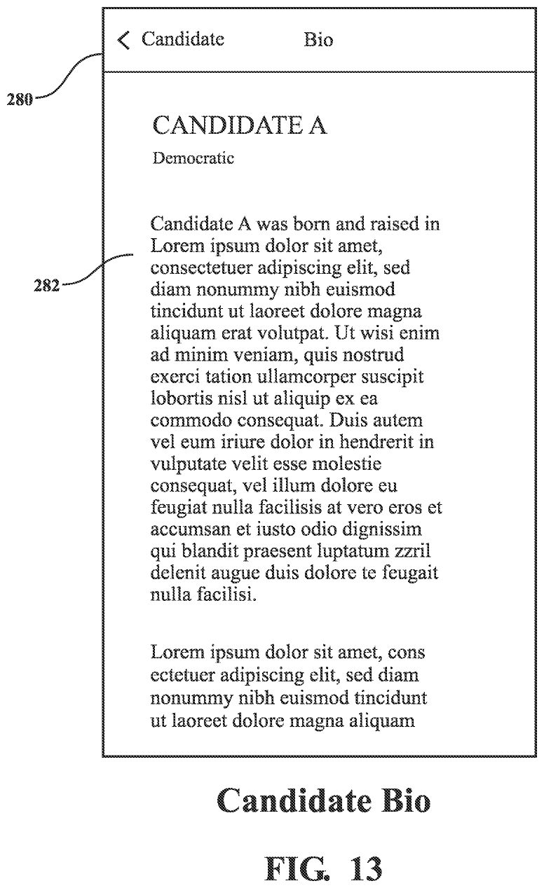

FIG. 13 is an illustrative screenshot of a candidate biography screen of an exemplary mobile application utilizing system 10. By selecting biography 274 from candidate profile screen 268, the user may be directed to a candidate biography screen 280. On candidate biography screen 280, biographical information 282 about a candidate may be displayed.

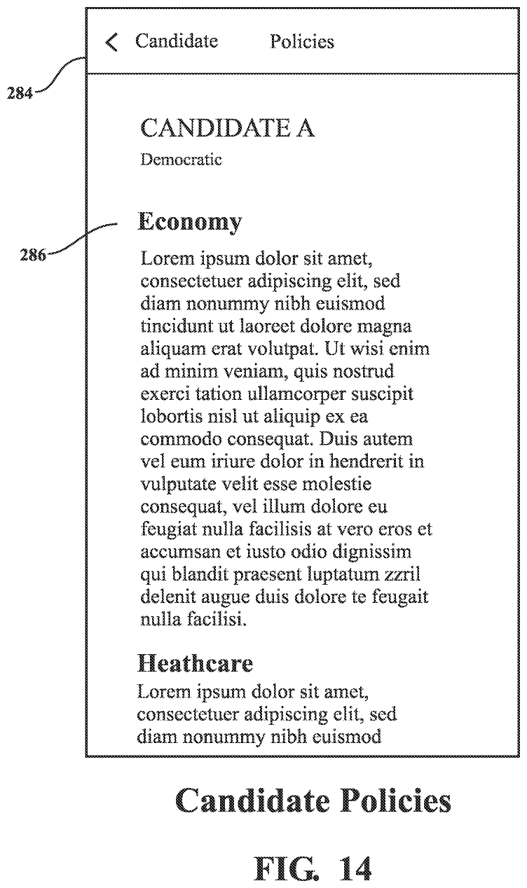

FIG. 14 is an illustrative screenshot of a candidate policies screen of an exemplary mobile application utilizing system 10. By selecting policies 276 from candidate profile screen 268, the user may be directed to a candidate policies screen 284. On candidate policies screen 284, policy/platform information 286 associated with a candidate may be displayed.

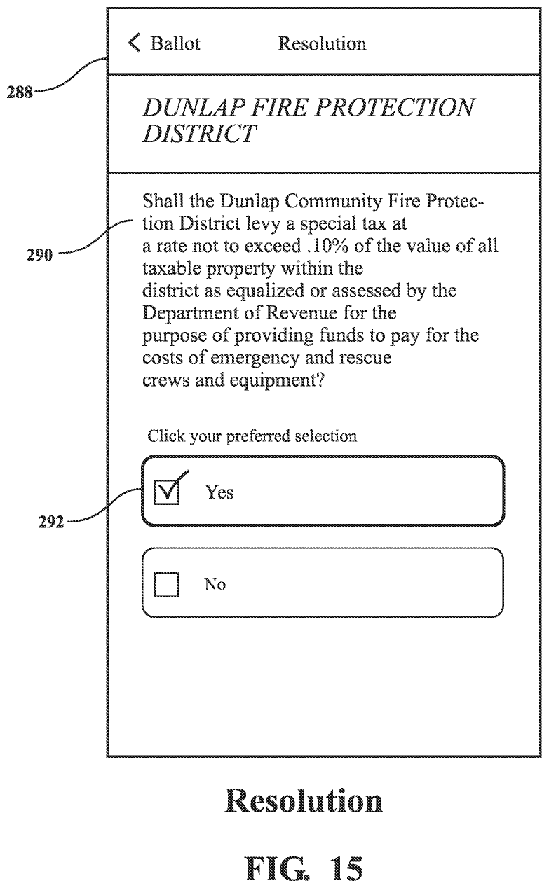

FIG. 15 is an illustrative screenshot of a resolutions screen of an exemplary mobile application utilizing system 10. By selecting a resolution 262 from ballot screen 254, the user may be directed to a resolutions screen 288. On resolutions screen 288, information 290 about a particular resolution may be displayed. In some embodiments, there may also be a checkbox 292 that a user may check to indicate the user's preferred vote on the resolution (e.g., “YES” or “NO”, “FOR” or “AGAINST”, etc.) to assist a user in keeping track of their voting preferences.

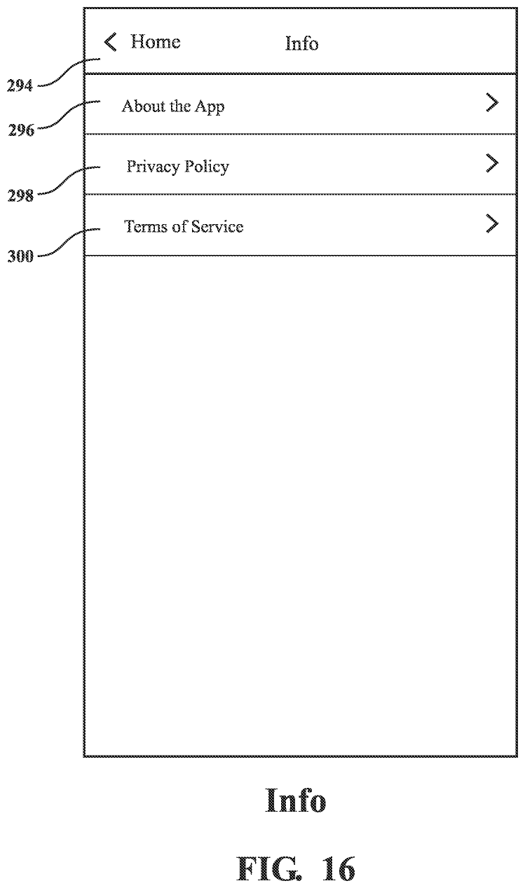

FIG. 16 is an illustrative screenshot of an information screen of an exemplary mobile application utilizing system 10. By selecting information 230 from home screen 220, the user may be directed to an information screen 294. On information screen 294, information about the application or website be displayed, including, for example, “about” information 296, privacy policy 298, and terms of service 300, which the user may select to bring up additional information.

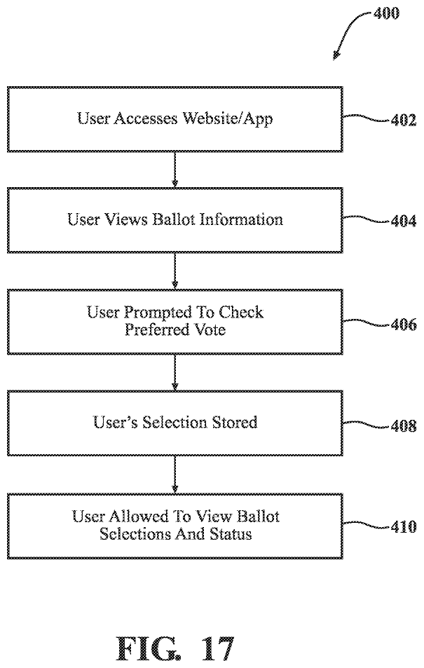

FIG. 17 illustrates a flowchart of a voter preference selection and storage method 400 that may be used with the system 10 shown in FIG. 1. The method includes a plurality of steps. Each method step may be performed independently of, or in combination with, other method steps. Portions of the method may be performed by any one of, or any combination of, the components of the system 10.

In a first step 402, a user accesses, via the communications unit 32 and the hosting unit 34, a website or mobile application and may log in or create an account and then log in (see, e.g., FIG. 3, method 100 above). In a second step 404, the user may be allowed to view a ballot associated with the user, such as for an upcoming election in which the user is entitled to cast a vote. The ballot information may include, for example, open offices and candidates therefor, and resolutions and voting options therefor, among other information or voting options (see, e.g., FIG. 10, above). In a third step 406, the user may be prompted to check a box associated with a candidate or voting option (yes/no, for/against, etc.) to indicate the user's preferred response on the ballot (see, e.g., box 278 of FIG. 12 and boxes 292 of FIG. 15). In a fourth step 408, the user's selection is stored, e.g., in database 22. In a fifth step 410, the user may be allowed to view his or her ballot selections and the status of all offices or ballot questions, including selections marked for each and/or an indication that no choice has yet been selected. This may be useful for the user to review before or during voting at the user's polling place, or the user may elect to print a screenshot to bring with him or her to the polling place to assist with recalling preferred ballot selections.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media. An apparatus may be expressed in terms of modules and/or units that include one or more discrete hardware components or portions thereof as configured by software (in any form). Furthermore, an apparatus may take the form of one or more elements expressed as a means for performing a specified function. When expressed in such a form, the means are to be interpreted as meaning the combination of hardware components or portions thereof contained within this specification, and any equivalents thereof.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object-oriented databases, and any other structured collection of records or data that is stored in a computer system. The above examples are exemplary only, and thus are not intended to limit in any way the definition and/or meaning of the term database. Examples of databases include, but are not limited to, only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

The above description of illustrated examples of the present invention are not intended to be exhaustive or to be limitation to the precise forms disclosed. While specific embodiments of, and examples for, the invention are described herein for illustrative purposes, various equivalent modifications are possible without departing from the broader spirit and scope of the present invention.

1. A system comprising:
a database stored on a server;
an application installed on a user device accessible to a user, wherein the user device includes a user interface; and
a processing device of the server, wherein the processing device is in communication with the user interface, the processing device including:
a hosting unit configured to:
prompt a user to access the application, and
display voter information associated with the user,
a voting management unit configured to maintain voting information, and
a communications unit configured to send information about voting to the user.

2. The system of claim 1, wherein the voting information maintained by the voting management unit includes voter registration information and polling place information.

3. The system of claim 1, wherein the voting information maintained by the voting management unit includes information about current ballots, candidates, and resolutions.

4. The system of claim 1, wherein the communications unit sends information to the user by way of at least one of an e-mail, a text message, and a push notification.

5. A computer-implemented method comprising:
prompting a user to access, by a hosting unit and a communications unit, a voter mobile application;
displaying, by the hosting unit, a current ballot associated with the user;
prompting the user, by the hosting unit, to select a voting option to indicate a preferred response associated with the user on the ballot;
storing, in a database, the selected voting option; and
displaying, by the hosting unit, all voting options associated with the current ballot selected by the user.

6. The computer-implemented method of claim 5, wherein the current ballot is for an upcoming election in which the user is entitled to cast a vote.

7. The computer-implemented method of claim 5, wherein the current ballot includes at least one of open offices and resolutions.

8. The computer-implemented method of claim 5, wherein the voting option is a “yes” or “no” option.

9. The computer-implemented method of claim 5, wherein the step of displaying of all voting options associated with the current ballot selected by the user includes displaying an indication that no choice has yet been selected for one or more voting options.

10. A non-transitory information recording medium on which a computer readable program is recorded that causes a computer to function as a system comprising:
a database stored on a server;
an application installed on a user device accessible to a user, wherein the user device includes a user interface; and
a processing device of the server, wherein the processing device is in communication with the user interface, the processing device including:
a hosting unit configured to:
prompt a user to access the application, and
display voter information associated with the user,
a voting management unit configured to maintain voting information, and
a communications unit configured to send information about voting to the user.

11. The non-transitory information recording medium of claim 10, wherein the voting information maintained by the voting management unit includes voter registration information and polling place information.

12. The non-transitory information recording medium of claim 10, wherein the voting information maintained by the voting management unit includes information about current ballots, candidates, and resolutions.

13. The non-transitory information recording medium of claim 10, wherein the communications unit sends information to the user by way of at least one of an e-mail, a text message, and a push notification.
